(19) United States
(12) Patent Application Publication
(10) Pub. No.: US 2014/0159270 A1
(43) Pub. Date: Jun. 12, 2014

(54) Crown Molding and Method of Use

(71) Applicant: Glenn Cosper, Cleburne, TX (US)

(72) Inventor: Glenn Cosper, Cleburne, TX (US)

(21) Appl. No.: 14/178,434

(22) Filed: Feb. 12, 2014

Related U.S. Application Data
(62) Division of application No. 13/440,559, filed on Apr. 5, 2012.

(51) Int. Cl. B29C 44/10

(52) U.S. Cl. CPC B29C 44/10
USPC 264/45.3

(57) ABSTRACT

A lightweight decorative crown molding is shown which is installed on a surface of a building structure. The molding has a body which is formed of molded high density polystyrene foam. The body forms an elongate strip having a decorative front face and a rear mounting face, the rear mounting face having one or more elongate mounting rails which run longitudinally along the rear face of the foam body for mounting the molding to the building surface. The relative thicknesses of the mounting rails and the remaining portions of the molding body are selected to allow the molding to be formed in a high density molding process.

### CROSS REFERENCE TO RELATED APPLICATIONS

The present application is a divisional application of Ser. No. 13/440,559, filed Apr. 5, 2012, entitled “Crown Molding and Method of Use”, by the same inventor.

### BACKGROUND OF THE INVENTION

1. Field of the Invention

The present invention relates generally to decorative moldings used in building structures and, more specifically, to a crown molding formed from a high density polystyrene which is generally attached at a wall-ceiling intersection and serves as a covering strip, especially for decorative purposes.

2. Description of the Prior Art

A variety of decorative moldings, such as crown moldings, door and window casings, chair rails, baseboards, etc., are commonly used in the building trades and will be familiar to those skilled in the relevant arts. These moldings have traditionally been provided having a flat surface on one side at least, and a decorative surface on the opposite, exposed side. The flat side or sides were used for mounting the molding strip to an interior wall surface.

In the prior art designs, the visually appealing decorative surface was usually formed in three dimensions with the molding often having a uniform cross-sectional profile. A uniform cross-sectional profile is the simplest molding to manufacture either of wood by milling the decorative surfaces, or in the case of extruded plastic molding by extruding through a uniform profile die. Wood moldings have been used for many years. However, at the present time, they suffer from the disadvantage of being increasingly expensive due to the labor intensive nature of the milling process and the gradual depletion of suitable forest also tend to shrink and may crack or chip during handling and installation. Thus, even though wood moldings have been the most common molding used in North America for many years, other less expensive alternatives are becoming popular.

Solid plaster moldings have been used since Victorian times, or before. It will be appreciated however, that the manufacture, handling and installation of traditional solid plaster molding involves significant expense, skilled labour and expertise. As a result, mass production of solid plaster moldings has not occurred due to the high relative costs, and the inherent risk of damage during shipping and installation.

An alternative to solid plaster molding or wood molding is plastic molding, which is typically manufactured via extrusion, and may be solid or formed with a solid skin surrounding a foam core. As noted above, molding, such as crown molding has conventionally been custom-cut and installed by skilled craftsmen because the installation of molding is very labor intensive and time consuming, especially for traditional, common wood molding. For example, wood molding must be properly and exactingly measured for the location it is to be used. Specifically, in each corner of the room, the molding segments must be precisely cut to form mitered and/or coped joints.

Mitering and coping are techniques requiring for proper installation, and are typically possessed by those skilled in the finish carpentry trade. Even where corner blocks are used instead of mitered joints, the molding pieces must be cut to precise and accurate lengths, which still require finish carpentry skills. With the increasing cost of skilled labor, and the increasing interest of homeowners in do-it-yourself home renovation projects, it has become desirable to provide a means for relatively unskilled persons working alone with a minimum of tools to easily install and maintain attractive moldings in the home.

Another difficulty results from the fact that traditional wood molding was typically nailed into place on the wall and/or ceiling. This type of construction technique usually requires locating the underlying wall and ceiling studs. Unfortunately, previous construction techniques at a particular site may have employed irregular and unpredictable spacing making stud location unpredictable.

Since it is often desirable to position a conventional molding joint on a stud (allowing both pieces to be joined to the same stud) locating stud position is important to proper installation. In other building situations, the substrate structure may have been formed of concrete, metal, brick, glass, etc. all of which were unsuitable for nailing.

It is an object of the present invention therefore to produce a crown interior molding which is low in cost and suitable for mass production.

It is a further object of the invention to provide a light weight interior molding which is of a weight such that the molding can be installed with adhesives, without the need for mechanical fasteners or nails to simplify installation and to reduce the level of skill involved.

It is a further object of the invention to provide a light weight interior molding which can be produced from high density polystyrene and which has a unique rail mounting system which simplifies installation and increases the versatility of the molding to fit a variety of underlying installation substrates.

### SUMMARY OF THE INVENTION

A lightweight decorative molding is provided for installation on an interior/exterior surface of a building structure, such as between a wall and a ceiling. The molding is formed of a molded high density polystyrene foam, the foam body being molded in the shape of an elongate strip having a decorative front face and a rear mounting face. The rear mounting face has at least one elongate mounting rail which runs longitudinally along the rear face of the foam body for mounting the molding to the interior building surface. Preferably, the mounting face has a plurality of such mounting rails which run parallel to each other on the rear mounting wall.

The mounting rails on the rear mounting face form elongate extensions which extends outwardly from the rear face which terminate in a flat, runner surface that serves as the mounting surface for the molding. The flat, runner surfaces of the mounting rails have ribs which run longitudinally along the length of the mounting face to facilitate the application of an adhesive to the runner surfaces. The molding body has a suitable thickness to allow it to be molded in a high density polystyrene molding process.

The lightweight decorative molding is preferably a crown molding which is formed in a high density polystyrene molding process comprising the steps of:

providing a compression mold apparatus with a mold cavity;
overfilling the mold cavity above a normal fill volume with polystyrene beads and compressing the beads in the mold cavity before adding heat to expand the polystyrene beads;
adding steam to the mold cavity to heat and expand the previously compressed polystyrene beads;
ejecting a finished crown molding from the cavity; and
wherein the mounting rails which extend outwardly from a remaining cross sectional portion of the molding body allow the remaining molding body to have a relatively thinner cross section, and wherein the relatively thinner cross section of the remaining molding body has a suitable thickness to allow it to be molded in the high density polystyrene molding process.

In the most preferred molding process, the molding of the invention is formed in a high density polystyrene molding process comprising the steps of:

providing a compression mold apparatus with a mold cavity;
introducing steam into the mold cavity to pre-heat the cavity;
filling the mold cavity to a normal 100% capacity plus and extra 10% volume of polystyrene beads, the mold then being filled to 110% normal volume capacity;
closing the mold cavity to thereby completely compact the extra 10% volume of polystyrene beads in the mold cavity;
introducing steam into the mold cavity to expand the polystyrene beads;
introducing cooling water into the mold cavity to cool the cavity;
vacuuming away any excess condensation or water from the mold cavity;
ejecting a finished crown molding from the cavity; and
wherein the mounting rails which extend outwardly from a remaining cross sectional portion of the molding body allow the remaining molding body to have a relatively thinner cross section, and wherein the relatively thinner cross section of the remaining molding body has a suitable thickness to allow it to be molded in the high density polystyrene molding process.

Additional objects, features and advantages will be apparent in the written description which follows.

### BRIEF DESCRIPTION OF THE DRAWINGS

FIG. 1 is a perspective view of a portion of a strip of the crown molding of the invention, in place on a ceiling, shown partly in section in order to illustrate the rail mounting system located on the rear face of the molding.

FIG. 2 is an isolated view of a portion of the molding strip of FIG. 1 showing the rails on the rear face thereof.

FIG. 3 is a side, cross sectional view of the molding strip of FIG. 2, taken along lines 3-3.

FIG. 4 is a perspective view of another molding strip of the invention, again showing the mounting rails located on the rear face thereof.

FIG. 5 is a side, cross sectional view of the molding strip of FIG. 4, taken along lines 5-5.

FIG. 6 is a view of the rear face of a section of crown molding of the invention, showing the ribs which run along one of the mounting rails.

FIG. 7 is a cross sectional view of the molding of FIG. 6 taken along lines 7-7.

### DETAILED DESCRIPTION OF THE INVENTION

The preferred version of the invention presented in the following written description and the various features and advantageous details thereof are explained more fully with reference to the non-limiting examples included in the accompanying drawings and as detailed in the description which follows. Descriptions of well-known components and processes and manufacturing techniques are omitted so as to not unnecessarily obscure the principle features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

As discussed in the Background of the Invention, decorative molding, such as crown molding, door and window casings, chair rails, baseboards, etc., are commonly used in the construction industry. Crown moldings, in particular, are commonly used to decorate a room by providing a decorative transition between a vertical wall and a ceiling. The moldings of the invention are particularly well suited for use as interior crown molding but could also, in some circumstances, be used in exterior applications, as under the eaves of a house.

Molding typically has a single decorative side, and a flat side that is mounted on a wall, ceiling, or floor surface. The visually appealing decorative surface is usually formed in three dimensions with the molding often having a uniform cross-sectional profile. A uniform cross-sectional profile is the simplest molding to manufacture, either of wood by milling the decorative surfaces, or in the case of extruded plastic molding, by extruding through a uniform profile die.

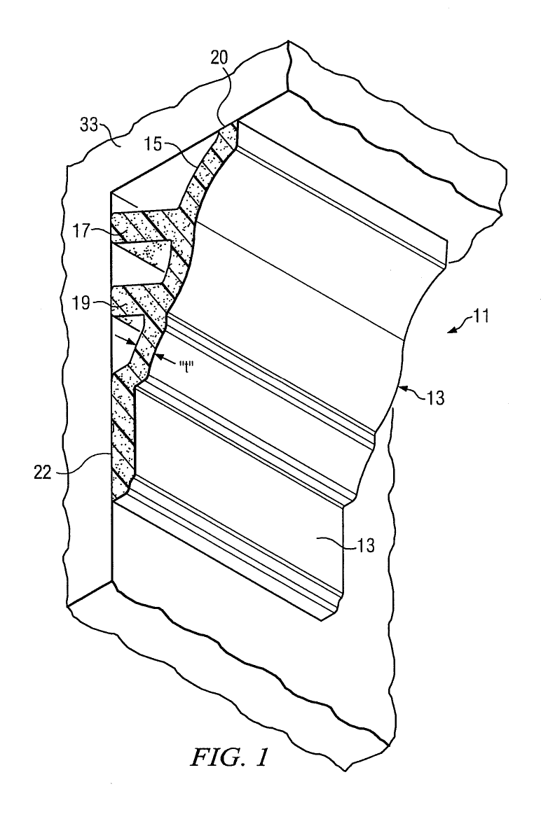

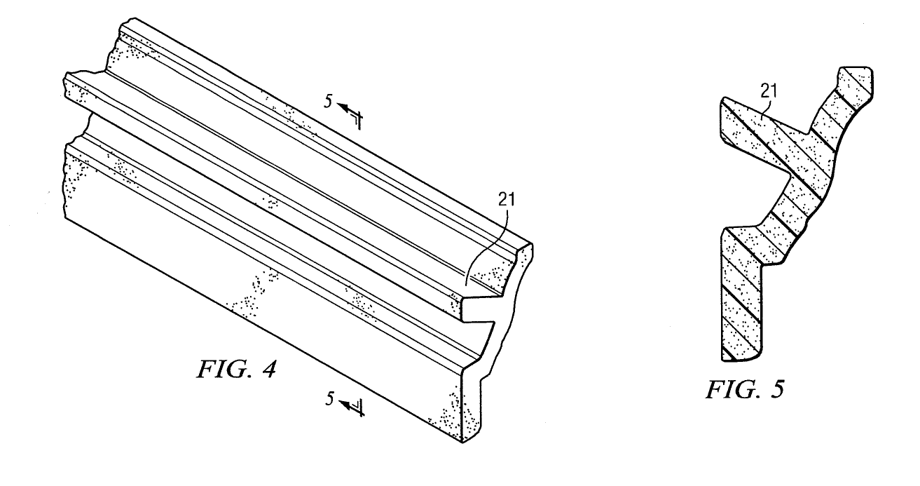

With reference to FIG. 1 of the drawings, the crown molding 11 of the invention comprises an elongate foam body 13 formed from a molded high density polystyrene foam. Only a segment of the whole strip of molding is shown for ease of illustration. The foam body is molded in the shape of an elongate strip having a decorative front face 13 and a rear mounting face 15. In the past, the molding strip would normally be six feet or less in length. Applicant's process for producing crown molding, to be more fully described, allows longer lengths, e.g., eight foot lengths. The rear mounting face has at least one elongate mounting rail 17 which runs longitudinally along the rear face of the foam body for mounting the molding to the interior building surface. In the version of the molding shown in FIG. 1, there are two mounting rails 17, 19 running generally parallel to one another on the rear mounting face 15. In the version of the invention shown in FIGS. 4 and 5, there is a single mounting rail 21.

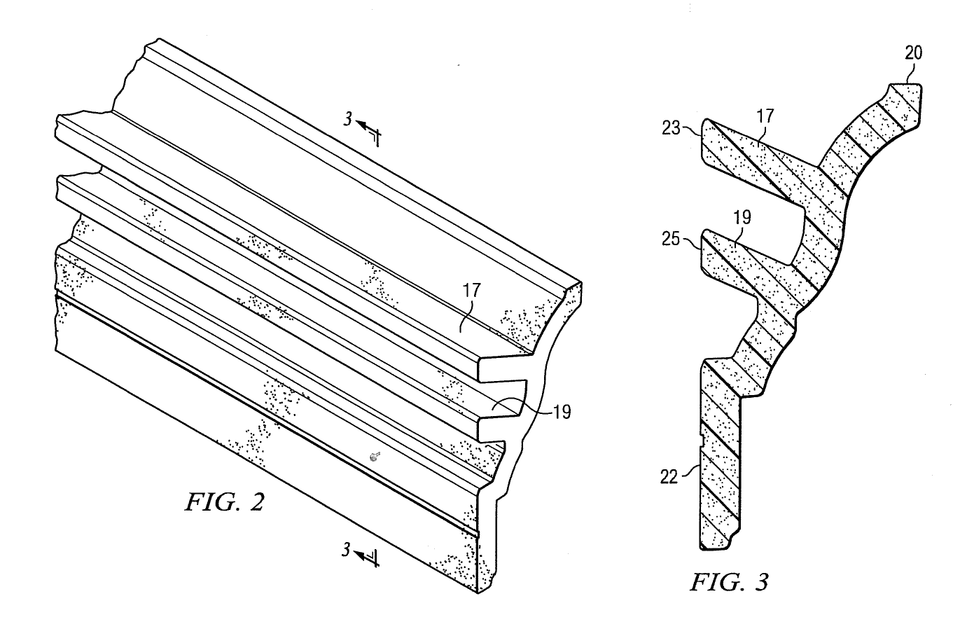

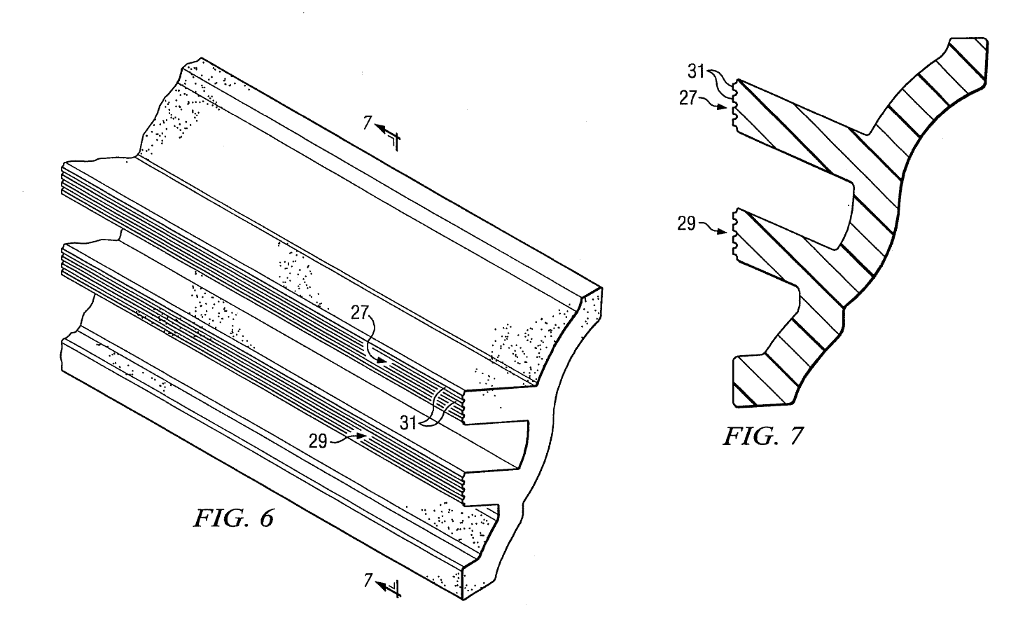

As will be appreciated with respect to FIGS. 2 and 3, the mounting rails 17, 19 form elongate extensions which extend outwardly from the rear face 15 (see FIG. 1) and which terminate in flat, runner surfaces 23, 25 (see FIG. 3) that serve as the mounting surface for the molding. In a particularly preferred form of the invention shown in FIGS. 6 and 7, the flat runner surfaces 27, 29 are provided with ribs (such as rib 31 in FIGS. 6 and 7) which run longitudinally along the length of the molding face to facilitate the application of an adhesive to the runner surfaces for mounting the molding on a wall. It can be appreciated from the perspective view of FIG. 1 that the molding of the invention with its “stand-off” rails 17, 19 allow it to be mounted to even a slanting ceiling 33. The molding can be glued to the wall without being affixed to the ceiling. Because the molding can be glued in place with a suitable adhesive, it can be mounted on a variety of substrates including steel, brick and glass, to name a few.

It will also be appreciated from FIG. 1 that the crown molding of the invention is of overall thinner cross sectional dimension than were traditional crown moldings formed with traditional “flat” backs. This is critical for purposed of the present invention in that the relatively thinner cross section allows the moldings of the invention to be formed in a compression, high density polystyrene molding process that would not be possible with the thicker prior art moldings. During the manufacturing process, steam and sometimes other gases are injected into the mold cavity through nozzles. The thicker cross section moldings of the prior art were too thick to allow the production gases to fully penetrate the foam. In other words, the mounting rails 17, 19 of Applicant's crown molding extend outwardly from a remaining cross sectional portion of the molding body (such as the thickness “t” in FIG. 1), wherein the remaining cross sectional portion of the molding body has a suitable thickness to allow it to be molded in a high density polystyrene molding process. The thickness “t” in FIG. 1 will typically be one half inch or less. The length of the strip of crown molding is not particularly critical, but as has been mentioned, longer lengths than the traditional six feet are possible with the process of the invention, for example eight feet lengths.

The process for forming the decorative crown molding of the invention will now be described in greater detail. The foam body is preferably formed in a “high density” polystyrene molding process. The following chart shows typical product characteristics for expanded polystyrene molded packaging. Densities range from 1.0 to 4.0 pound per cubic foot. By “high density” polystyrene, as used herein, Applicant means a density of over 1.0 pcf and preferably in the range from about 1.5 to 2.0 pcf, or even greater.

TABLE 1
Typical Properties of EPS Molded Packaging
(70 F. Test Temperature)

| | Stress @10% | Flexural | Tensile | Shear |
|---|---|---|---|---|
| Density | Compression | Strength | Strength | Strength |
| (pcf) | (psi) | (psi) | (psi) | (psi) |
| 1.0 | 13 | 29 | 31 | 31 |
| 1.5 | 24 | 43 | 51 | 53 |
| 2.0 | 30 | 58 | 62 | 70 |
| 2.5 | 42 | 75 | 74 | 92 |
| 3.0 | 64 | 88 | 88 | 118 |
| 3.3 | 67 | 105 | 98 | 140 |
| 4.0 | 80 | 125 | 108 | 175 |

* Note:
Values based on ASTM short-term, laboratory-load conditions. Both temperatures and time period of loading may affect end-point value.

First with respect to traditional expanded polystyrene, polystyrene is formed from many molecules of styrene being linked together through polymerization. Expanded polystyrene starts as small spherical beads with a typical diameter of 0.5-1.5 mm which are formed when the styrene is heated and pressurized with oxygen. The styrene molecules connect with other styrene molecules to form a new stronger bond, forming polystyrene. Once polystyrene is formed, it can be expanded. The process starts with many round beads of hard polystyrene, the beads having a hydrocarbon component. Heat applied in the form of steam causes the hydrocarbon to boil and the beads to soften.

Once softened, the beads are able to expand to around 40 times their beginning size. The now foamed polystyrene is allowed to cool somewhat and is then placed in molds. The foam is reheated so that it will expand again and fill the mold. The heat is applied until the individual foam beads link together forming a bond. The mold can be designed to meet any requirements of the customer. This process has been in use commercially for many years and will be familiar to those skilled in the relevant arts

The crown molding of the invention is made by a somewhat similar process, differing primarily in the fact that the mold is intentionally overfilled with polystyrene beads which are then compressed. For example, in Applicant's process, the polystyrene beads would fill the mold 100% full plus an extra 10%. Then the mold that is at 110% volume would be compressed to 100% of the mold's volume. Heat and steam would then be introduced to expand the polystyrene beads into a higher density material. Applicant's process differs from the industry-standard procedure for expanded polystyrene in that Applicant's mold is intentionally overfilled and compressed whereas the mold in the industry standard process is normally never filled completely or compressed before the expansion process is begun. In the industry standard process, the filling range would typically range between 80 to 100% of the mold chamber volume, leaving open air volume inside of the mold to be filled by the expansion of the polystyrene beads. That process generally results in a softer, less dense product which is more easily broken than Applicant's crown molding product.

A preferred process for forming the crown molding of the invention thus comprises:

comprising the steps of:
providing a compression mold apparatus with a mold cavity;
overfilling the mold cavity above a normal fill volume with polystyrene beads and compressing the beads in the mold cavity before adding heat to expand the polystyrene beads;
adding steam to the mold cavity to heat and expand the previously compressed polystyrene beads;
ejecting a finished crown molding from the cavity; and
wherein the mounting rails which extend outwardly from a remaining cross sectional portion of the molding body allow the remaining molding body to have a relatively thinner cross section, and wherein the relatively thinner cross section of the remaining molding body has a suitable thickness to allow it to be molded in the high density polystyrene molding process.

In a particularly preferred method of the invention, the molding process comprises the steps of:

providing a compression mold apparatus with a mold cavity;
introducing steam into the mold cavity to pre-heat the cavity;
filling the mold cavity to a normal 100% capacity plus and extra 10% volume of polystyrene beads, the mold then being filled to 110% normal volume capacity;
closing the mold cavity to thereby completely compact the extra 10% volume of polystyrene beads in the mold cavity;
introducing steam into the mold cavity to expand the polystyrene beads;
introducing cooling water into the mold cavity to cool the cavity;
vacuuming away any excess condensation or water from the mold cavity;
ejecting a finished crown molding from the cavity; and
wherein the mounting rails which extend outwardly from a remaining cross sectional portion of the molding body allow the remaining molding body to have a relatively thinner cross section, and wherein the relatively thinner cross section of the remaining molding body has a suitable thickness to allow it to be molded in the high density polystyrene molding process.

The exact operating parameters, temperatures, pressures, etc., used in the process are typical of those used in the art and will be within the skill of one skilled in the expanded polystyrene arts. See, for example, L. Arnold, “Introduction to Plastics”, Iowa State University Press, (1968) p. 106-109; and K. Goodier, “Making and Using An Expanded Plastic”, New Scientist, (1961) 240:706 and many similar sources on the subject.

Compression molding machines of the type under consideration can be obtained commercially from various sources. As one example, there are the Kurtz Ersa “A”, “T” and “N” Line Shape Molding Machines available from Kurtz Holding GmbH & Co. Beteiligungs KG, Industriegebiet Wiebelbach, Frankenstr. 2, Germany D-97892.

An invention has been provided with several advantages. The mounting rails which extend from the rear face of the molding to the mounting wall surface have many advantages over conventional crown moldings. Conventional crown moldings require two mounting surfaces for installation. They also generally require a horizontal top ceiling surface and a vertical wall surface. The crown molding of the invention, on the other hand, can be mounted to the wall surface only, thereby eliminating the need for a horizontal ceiling area to mount. As a result, no ceiling or horizontal ceiling surface is needed. The crown molding of the invention can be mounted to concrete, brick, stone, stucco, plaster, sheet rock, drywall, wood, glass, steel, aluminum surfaces etc. without the use of any fasteners. The crown molding of the invention requires no studs or structural backing for installation.

The result is that Applicant's crown molding is very easy to install by even an inexperienced person. Unlike conventional crown moldings no hammers, nails, stud finders, electric miter saws and expensive tools are needed. The flat back molding of the invention makes it very simple to cut in an electric miter saw. The mounting rails on the rear face of the molding allows it to be placed flat up against the fence of an electric miter saw for ease in positioning when cutting the molding.

While the invention has been shown in two of its forms, it is not thus limited and is susceptible to various changes and modifications without departing from the spirit thereof.

I claim:

1. A method of manufacturing a lightweight decorative molding formed in a high density polystyrene molding process, which decorative molding can be installed at a juncture of a wall and a ceiling within an interior of a building structure, the method comprising the steps of:
providing a compression mold apparatus with a mold cavity;
overfilling the mold cavity above a normal fill volume with polystyrene beads and compressing the beads in the mold cavity before adding heat to expand the polystyrene beads;
adding steam to the mold cavity to heat and expand the previously compressed polystyrene beads;
ejecting a finished crown molding from the cavity;
the finished crown molding being molded in the shape of an elongate strip having a decorative front face and a rear mounting face, the rear mounting face having a plurality of elongate mounting rails which run longitudinally along the rear face of the foam body for mounting the molding to the juncture of the wall and ceiling of the interior of the building structure;
the mounting rails on the rear mounting face forming elongate extensions which extends outwardly from the rear face which terminate in a flat, runner surface that serves as a mounting surface for the molding, the flat, runner surfaces of the mounting rails being formed with ribs which run longitudinally along the length of the mounting face to facilitate the application of an adhesive to the runner surfaces.

2. A method of manufacturing a lightweight decorative molding formed in a high density polystyrene molding process, which decorative molding can be installed at a juncture of a wall and a ceiling within an interior of a building structure, the method comprising the steps of:
providing a compression mold apparatus with a mold cavity;
introducing steam into the mold cavity to pre-heat the cavity;
filling the mold cavity to a normal 100% capacity plus and extra 10% volume of polystyrene beads, the mold then being filled to 110% normal volume capacity;
closing the mold cavity to thereby completely compact the extra 10% volume of polystyrene beads in the mold cavity;
introducing steam into the mold cavity to expand the polystyrene beads;
introducing cooling water into the mold cavity to cool the cavity;
vacuuming away any excess condensation or water from the mold cavity;
ejecting a finished crown molding from the cavity;
the finished crown molding being molded in the shape of an elongate strip of a given length which has a density of at least about 1.0 pound per cubic foot and having a decorative front face and a rear mounting face, the rear mounting face having a plurality of elongate mounting rails which run longitudinally along the rear face of the foam body for mounting the molding to the juncture of the wall and ceiling of the interior of the building structure;
the mounting rails on the rear mounting face forming elongate extensions which extends outwardly from the rear face which terminate in a flat, runner surface that serves as the mounting surface for the molding, the flat, runner surfaces of the mounting rails being formed with ribs which run longitudinally along the length of the mounting face to facilitate the application of an adhesive to the runner surfaces, the mounting rails being formed to be less than one half inch thick along the entire length of the elongate strips.

3. The method of claim 15, wherein the decorative light weight molding is made from molded high density polystyrene foam body having a density greater than about 1.5 pounds per cubic foot.

4. The method of claim 15, wherein the decorative light weight molding which is formed in the compression mold apparatus is greater than six feet in length.
